(19) United States
(12) Patent Application Publication
(10) Pub. No.: US 2020/0096928 A1
(43) Pub. Date: Mar. 26, 2020

(54) INFORMATION PROCESSING APPARATUS AND STORAGE MEDIUM

(71) Applicant: CANON KABUSHIKI KAISHA, Tokyo (JP)

(72) Inventor: Akihiro Moriya, Kashiwa-shi (JP)

(21) Appl. No.: 16/569,970

(22) Filed: Sep. 13, 2019

(30) Foreign Application Priority Data
Sep. 25, 2018 (JP) 2018-179332

(51) Int. Cl. G03G 15/00; G06F 3/12

(52) U.S. Cl. CPC G03G 15/553; G03G 15/502; G06F 3/1235; G06F 3/121; G03G 15/5079

(57) ABSTRACT

To provide a mechanism that improves convenience of a user who uses an automatic order service of consumable products and the like. In an information processing apparatus that is connected via a network to an apparatus which has a capability of receiving an automatic order service for consumable product, an application that manages the consumable product is installed. This application has a function to display a site relating to the consumable product on a display unit of the information processing apparatus. Then, the site that is displayed on the display unit is different between a case where the apparatus has been registered to the service for receiving the automatic order service and a case where the apparatus has not been registered to the service.

### BACKGROUND OF THE INVENTION

### Field of the Invention

The present invention relates to a technique to provide information to a user who uses an apparatus that needs to exchange consumable products and the like in order to maintain the apparatus performance and the like.

### Description of the Related Art

In an image forming apparatus that performs printing on a sheet and the like by using color materials, a variety of consumable products exist, such as cartridges containing color materials, printing sheets, and conveyance rollers. Further, in a case of an electrophotographic image forming apparatus, developing devices, electrifying devices, photoconductor drums, and the like also correspond to the consumable products, and it is necessary to purchase and exchange those units as needed. In order to simplify time and effort of a user relating to purchase of those consumable products, there is a case where a vendor or the like prepares a service of automatically ordering a consumable product to a predetermined order destination.

The mechanism of the automatic order service for consumable product as described above is in general such that, for example, a cartridge is automatically ordered in a case where the color material remaining amount becomes less than or equal to a predetermined threshold value. At this time, in order to prevent an automatic order contrary to the intention of a user from being made, a technique to proceed with the purchase after, for example, the user him/herself checks the remaining amount of a consumable product has been proposed (Japanese Patent Laid-Open No. 2010-61694).

Further, in view of that it is not necessary for a user to take care of the remaining amount of a color material in a case where the user has subscribed to the automatic order service for consumable product, a technique to determine timing of a notification of the consumable product remaining amount in accordance with the state of subscription to the service has also been proposed (Japanese Patent Laid-Open No. 2017-65155).

In a case where a user uses the automatic order service for consumable product described above, provision of various kinds of information that recommends a user to purchase a consumable product, for example, guidance to an on-line shopping site or to a site that recommends over-the-counter purchase, is not necessary for the user and is rather troublesome. With the technique of the above-described Japanese Patent Laid-Open No. 2010-61694, it is possible to prevent the consumable product automatic order contrary to the intention of a user, but it is not possible to suppress the unnecessary information provision such as this. Further, only by changing the timing of a notification of the consumable product remaining amount as in the technique of Japanese Patent Laid-Open No. 2017-65155 described above, for example, in a case where a user forgets having subscribed to the automatic order service, there is a possibility that the user erroneously purchases the consumable product in accordance with guidance (duplicate order).

The present invention has been made in view of the above-described problems and an object is to provide a mechanism to improve convenience of a user who uses an automatic order service of consumable products and the like.

### SUMMARY OF THE INVENTION

The information processing apparatus according to the present invention is an information processing apparatus that is connected via a network to an apparatus which has a capability of receiving an automatic order service for consumable product and in which an application that manages the consumable product is installed, and the application has a function to display a site relating to the consumable product on a display unit of the information processing apparatus and the site that is displayed on the display unit is different between a case where the apparatus has been registered to the automatic order service and a case where the apparatus has not been registered to the automatic order service.

Further features of the present invention will become apparent from the following description of exemplary embodiments with reference to the attached drawings.

### BRIEF DESCRIPTION OF THE DRAWINGS

FIG. 1 is a block diagram showing an example of a configuration of a system that implements an automatic order service for consumable product;

FIG. 2 is a diagram showing an example of a software configuration of an SFP;

FIG. 3A is a diagram showing a software configuration of an information management server and FIG. 3B is a diagram showing a software configuration of a PC;

FIG. 4 is a flowchart showing a flow of an operation by a consumable product management application;

FIG. 5 is a diagram showing an example of service registration information;

FIG. 6 is a diagram showing an example of information stored in an access destination DB;

FIG. 7 is a diagram showing an example of a consumable product status screen;

FIG. 8A is a diagram showing an example of a cartridge automatic order service screen and FIG. 8B is a diagram showing an example of a cartridge purchase reception screen; and

FIG. 9 is a flowchart showing a flow of processing for an SFP to acquire and store service registration information.

### DESCRIPTION OF THE EMBODIMENTS

Hereinafter, with reference to the attached drawings, the present invention is explained in detail in accordance with preferred embodiments. Configurations shown in the following embodiments are merely exemplary and the present invention is not limited to the configurations shown schematically.

### First Embodiment

### (System Configuration and Hardware Configuration)

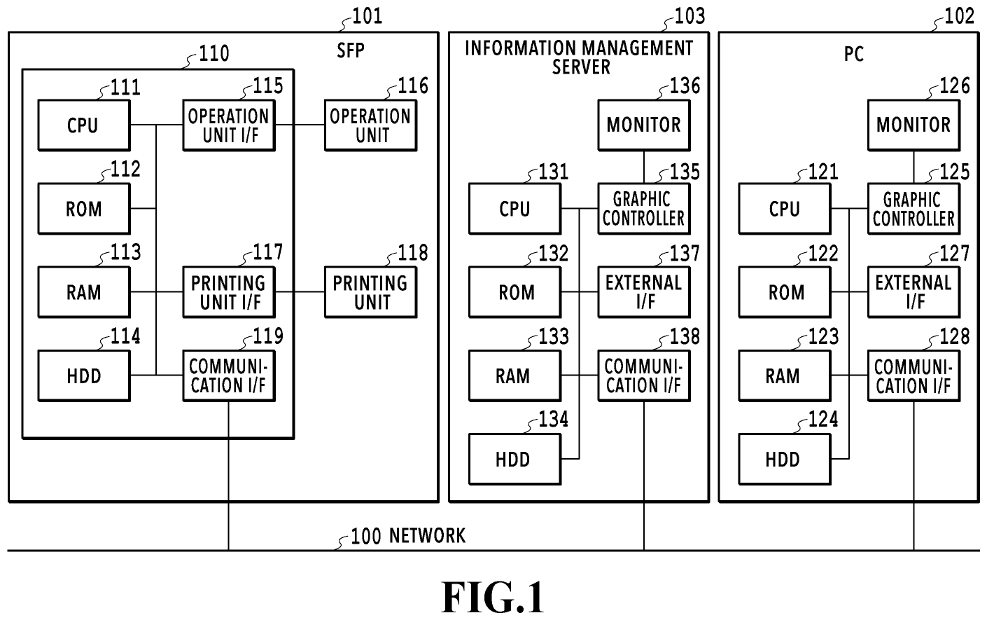

FIG. 1 is a block diagram showing an example of the configuration of a system that implements an automatic order service for consumable product according to the present embodiment. The system shown in FIG. 1 includes an SFP (Single Function Printer) 101, which is an electrophotographic image forming apparatus, a PC 102, which is an information processing apparatus, and an information management server 103 and these are connected so as to be capable of communication via a network 100, such a LAN. In the present embodiment, explanation is given by taking a case as an example where cartridges containing color materials (toner) used in the SFP 101 specialized in the print function are registered to the automatic order service. However, the article that is the target of the automatic order service is not limited to cartridges and may be, for example, printing sheets, conveyance rollers, and the like. Further, the target apparatus is not limited to the SFP and may be an MFP (Multi Function Printer) including a plurality of functions, such as the scan function, in addition to the print function. In the case such as this, for example, rollers or pads of the scan mechanism may be the target article of the automatic order service. Further, the target apparatus may be a so-called post-processing apparatus (finisher apparatus including the staple function and the punch function for a printout document) not having the print function. In a case of the post-processing apparatus, what is the target of the automatic order service is staples for exchange on a condition that the apparatus is an apparatus that performs stapling processing, recovery boxes of punch chips on a condition that the apparatus is an apparatus that bores a punch hole, and the like. Further, the target apparatus may be an apparatus having no relation with printing processing and may be any apparatus as long as for which the service of automatically ordering maintenance items for maintaining the apparatus performance or for exhibiting the original function of the apparatus is prepared by a vendor or the like. That is, any apparatus that needs to exchange or replenish consumable products or articles used for maintenance management regularly or irregularly may widely be a target.

The configuration of the system is not limited to this and for example, the number of PCs 102 may be two or more. Further, for example, the SFP 101 may also include the function of the information management server 103.

First, the hardware configuration of the information management server 103 is explained. The information management server 103 includes a CPU 131, a ROM 132, a RAM 133, an HDD 134, a graphic controller 135, a monitor 136, an external I/F 137, and a communication I/F 138 and these are connected so as to be capable of communication via a bus. The CPU 131 includes a computing circuit and centralizedly controls the information management server 103. The CPU 131 reads programs stored in the ROM 132 or the HDD 134 onto the RAM 133 and performs various kinds of processing. The ROM 132 stores a system program and the like. The RAM 133 is used as a work area of the CPU 131. The graphic controller 134 generates a UI screen that is displayed on the monitor 135. The HDD 134 as a large-capacity storage device stores various application programs, data, and the like. In place of the HDD, an SSD (Solid State Drive) or the like may be used. The external I/F 137 connects a keyboard, a mouse, and the like via an external I/F. The communication I/F 138 is an interface for communicating with the SFP 101 and the PC 102.

Next, the hardware configuration of the PC 102 is explained. The PC 102 is an information processing apparatus as a client terminal capable of accessing the SFP 101 via the network 100 and the basic hardware configuration is the same as that of the information management server 103 described above. That is, the PC 102 includes a CPU 121, a ROM 122, a RAM 123, an HDD 124, a graphic controller 125, a monitor 126, an external I/F 127, and a communication I/F 128 and each component is connected so as to be capable of communication via a bus. It is possible for the PC 102 to cause the SFP 101 to perform printing processing by transmitting a print job.

Next, the hardware configuration of the SFP 101 is explained. The SFP 101 is an image forming apparatus specialized in printing processing. A control unit 110 including a CPU 111 controls the operation of the entire SFP 101. The CPU 111 reads control programs stored in a ROM 112 or an HDD 114 and performs printing control and the like. The ROM 112 stores control programs executed by the CPU 111. A RAM 113 is a main storage memory of the CPU 111 and is used as a temporary storage area for loading various control programs stored in the ROM 112 and the HDD 114. The HDD 114 as a large-capacity storage device stores print jobs, various programs, various pieces of setting information, and the like. An operation unit I/F 115 is an interface that connects an operation unit 116 and the control unit 110. The operation unit 116 includes, for example, a touch panel display and hard keys and is used for a user to give various instructions and perform setting. A printing unit I/F 117 is an interface that connects a printing unit 118 and the control unit 110. The printing unit 118 receives a print command and print data via the control unit 110 and prints an image on a sheet (printing medium) based on the print data. The sheet also includes a plastic sheet and the like, other than paper. The printing method of the printing unit 118 is the electrophotographic method in the present embodiment, but the printing method is not limited to this. For example, another method, such as an ink jet method, may be adopted. In a case of the electrophotographic method, after forming an electrostatic latent image on a photoconductor, the electrostatic latent image is developed by toner, the toner image is transferred onto a sheet, and an image is formed by fixing the transferred toner image. A cartridge filled with toner is attached to the inside of the SFP 101 detachably. In a case where the toner within the cartridge runs short, a user exchanges the cartridge with a new cartridge. The CPU 111 acquires information indicating the use situation of the cartridge at predetermined timing, such as once a day, each time one page is printed, and at the time of attachment of a cartridge, and stores the acquired information in the RAM 113 or the like. Here, the information indicating the use situation of a cartridge includes the cartridge serial number, the toner color, the capacity, the maker name, and the like, in addition to the toner remaining amount. In the present embodiment, the toner remaining amount is explained by the percentage representation, but the level representation, for example, such as Normal and Low, may be adopted. The basic information, such as the cartridge serial number, is stored in the RAM 113 or the like at the time of attachment. In the present embodiment, the target article of the automatic order service is cartridges, and therefore, the toner remaining amount within a cartridge is acquired and stored. In a case where the target article of the automatic order service is printing sheets or conveyance rollers, for example, information capable of estimating the amount used or the degree of wear, for example, such as the number of printing-processed sheets (number of sheets passed), is acquired and stored.

Further, the control unit 110 is connected to the network 100 via a communication I/F 119. The communication I/F 119 acquires information indicating whether or not the SFP 101 is registered as the target product of the cartridge automatic order service (whether a user has subscribed to the service) from the information management server 103 on the network 100. Further, the communication I/F 119 receives a print job from the PC 102, transmits the above-described cartridge information stored in the RAM 113 or the like to the PC 102, and so on. The print job received via the communication I/F 119 is analyzed by a software module (PDL analysis unit, not shown schematically) for analyzing PDL data included in a print job. The PDL analysis unit interprets PDL data represented in a page description language and generates print data to be supplied to the printing processing in the printing unit 118. Further, the communication I/F 119 provides information on a remote operation screen to be displayed on the monitor 126 of the PC 102 to the PC 102 via the network 100.

### (Software Configuration)

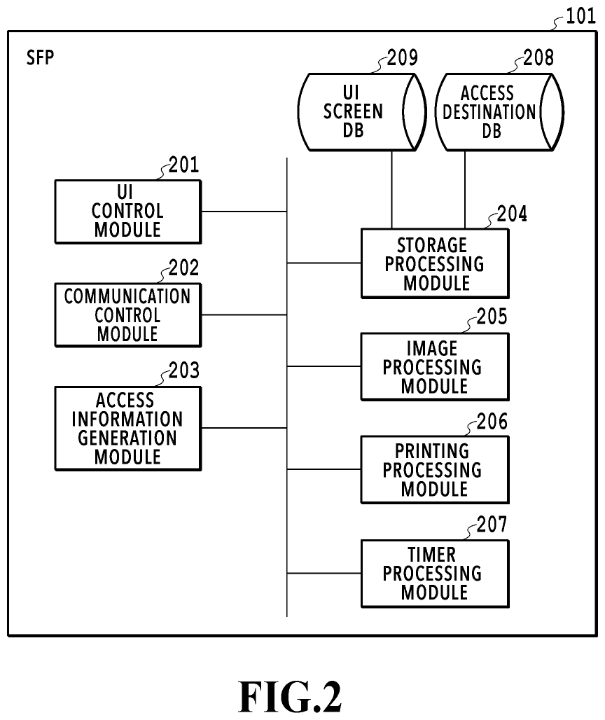

FIG. 2 is a diagram showing an example of the software configuration of the SFP 101. Each function module shown in FIG. 2 is implemented by the CPU 111 within the SFP 101 executing a predetermined control program. A UI control module 201 performs display control and input reception control at the operation unit 116 via the operation unit I/F 115. Specifically, the UI control module 201 displays information necessary for a user, alternatives, and the like on a display, receives an input operation by a user, notifies another function module of the contents thereof, and so on. A communication control module 202 controls connection/disconnection of a network, such as a LAN, and transmission and reception of data and commands via the communication I/F 119. An access information generation module 203 generates an access destination URL, to be described later. A storage processing module 204 stores specified data in the ROM 112, the RAM 113, and the HDD 114 in accordance with instructions from another function module, reads data stored in those units, and so on. An image processing module 205 generates and modifies print data to be supplied to the printing processing in the printing unit 118 based on the print job received from the PC 102 or the like. A printing processing module 206 controls the printing processing in the printing unit 118 by sending out various control commands to the printing unit 118 via the printing unit I/F 117, performing monitoring of the state of the printing unit 118, and so on. A timer processing module 207 performs time count processing and determines whether or not a predetermined time has elapsed. An access destination DB 208 is a database storing access information for a user to access information relating to a cartridge for exchange. A UI screen DB 209 is a database storing data of various user interface screens.

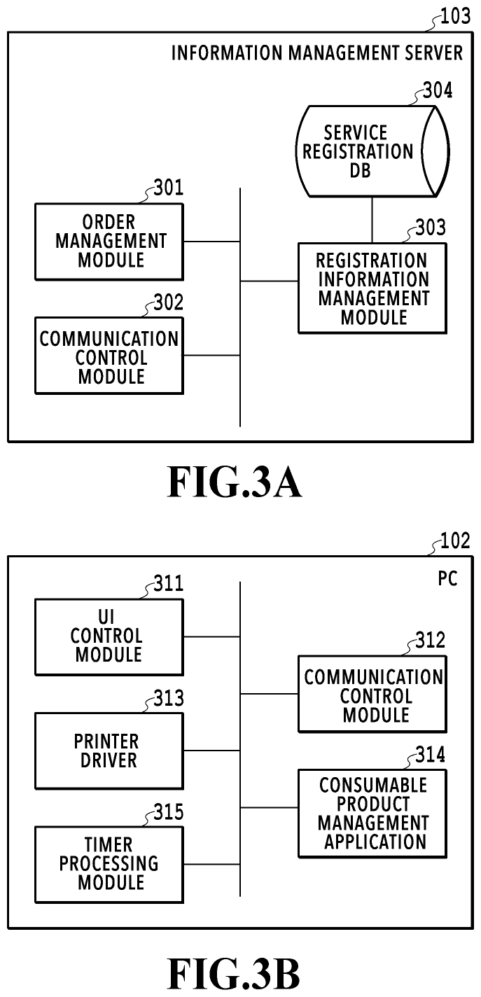

FIG. 3A is a diagram showing the software configuration of the information management server 103 and FIG. 3B is a diagram showing the software configuration of the PC 102. Each function module shown in FIG. 3A and FIG. 3B is implemented by the CPU 131 or 121 executing a predetermined control program.

First, the software configuration of the information management server 103 is explained. An order management module 301 is a module that refers to cartridge information on the SFP 101, which is received via the communication I/F 137, at the time of registration of the cartridge automatic order service and performs order processing of a cartridge in a case where the toner remaining amount becomes less than or equal to a predetermined threshold value (for example, 10%). The predetermined threshold value is set to an arbitrary value by a user at the time of service contract, or the like. A communication control module 302 is a module that controls connection/disconnection of the network 10, such as a LAN, and transmission and reception of data and commands via the communication I/F 138. A registration information management module 303 refers to the service registration information stored in a service registration DB 304 in response to an inquiry (polling) from the SFP 101 and returns whether the SFP 101 is registered as the target of the cartridge automatic order service to the SFP 101. It is assumed that for the automatic order service, prior registration is performed in a variety of units (for example, in units of users, in units of apparatuses, in units of offices).

Next, the software configuration of the PC 102 is explained. A UI control module 311 controls the monitor 126 via the graphic controller 125. In the second embodiment, the UI control module 311 performs display control at the time of a user checking purchase information on a consumable product and the like by remote access via a WEB browser. A communication control module 312 controls connection/disconnection of the network 100, such as a LAN, and transmission and reception of data and commands via the communication I/F 128. A printer driver 313 boots in a case where a user gives instructions to print document data and the like from various applications (not shown schematically) and performs various kinds of setting relating to the printing processing using the SFP 101, in addition to generation of a print job. In a print job, PDL data obtained by converting document data relating to printing instructions of a user into a page description language that the SFP 101 can interpret is included and the generated print job is sent to the SFP 101 via the network 100. The printer driver 313 is installed in the PC 102 at the time of registration of the SFP 101 and the printer driver 313 grasps the printers that the printer driver 313 itself supports. That is, in a case where printers of different models are connected on the network, printer drivers in accordance with each model are installed in the PC 102. A consumable product management application 314 is a resident application that boots at the same time the OS of the PC 102 boots. The consumable product management application 314 periodically monitors the consumption situation of consumable products in the target apparatus by polling and presents information necessary for a user based on the results. In the present embodiment, the consumable product management application 314 periodically acquires information on the toner remaining amount of each cartridge attached to the printing unit 118 of the SFP 101 and in a case where a cartridge whose toner remaining amount is less than or equal to a predetermined amount is detected, notifies a user of the fact. Then, the consumable product management application 314 displays the site relating to the cartridge for exchange on the Web browser in response to instructions of a user. The access information (URL) necessary at the time of producing a site display is provided by the SFP 101 along with the information on the toner remaining amount. The consumable product management application 314 is included in the integration installer at the time of installing the printer driver 313 and grasps the printers that the consumable product management application 314 itself supports like the printer driver 313. A timer processing module 315 performs time count processing and determines whether or not a predetermined time has elapsed like the timer processing module 207 of the SFP 101

In the software configuration described above, highly relevant modules for explanation of the present invention are enumerated and modules are not limited to those modules and another module, not shown schematically, may also be included.

### (Operation of Consumable Product Management Application)

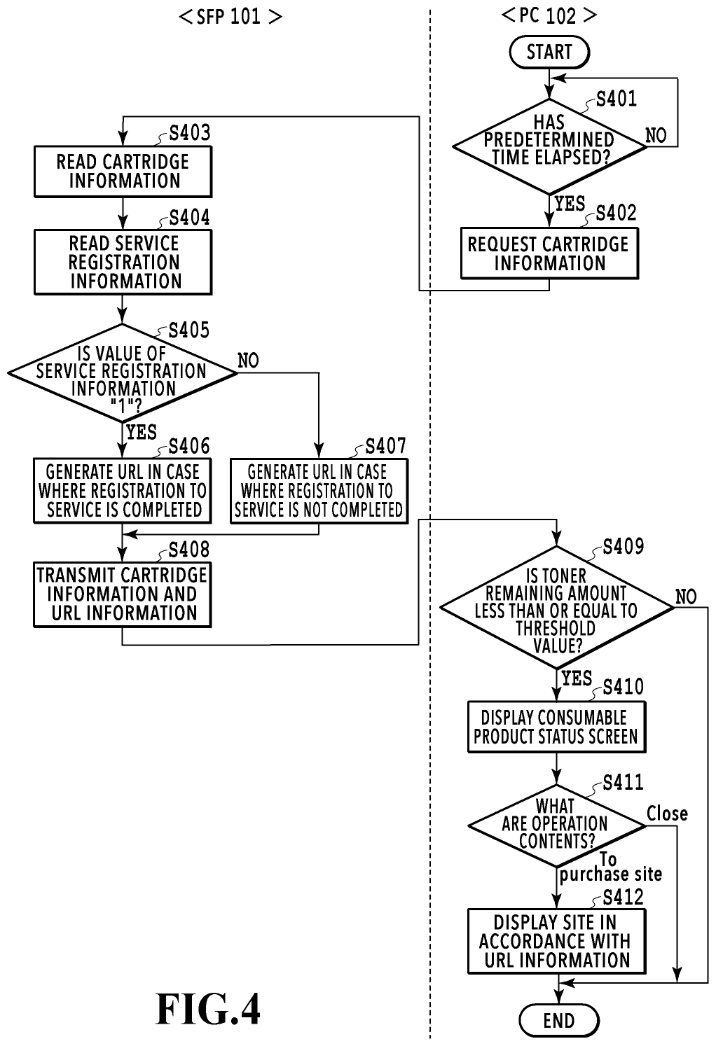

FIG. 4 is a flowchart showing a flow of the operation by the consumable product management application 314. Of each operation (step) shown in FIGS. 4, S401, S402, and S409 to S412 are performed on the side of the PC 102 and S403 to S408 are performed on the side of the SFP 101. Then, it is assumed that each of these steps is implemented by the CPU loading the control program stored in the ROM or the HDD onto the RAM and executing the control program in each of the PC 102 and the SFP 101. In the following explanation, “S” represents a step.

First, at S401, by the timer processing module 315 of the PC 102, whether a predetermined time specifying a polling interval that is set to a timer has elapsed is determined. It is possible for a user to arbitrarily set the predetermined time specifying the polling interval and for example, in a case where information is acquired each time one hour elapses, “3,600 (sec)” is set. In a case where the predetermined time has elapsed, at S402 that follows, the above-described cartridge information is requested from the SFP 101.

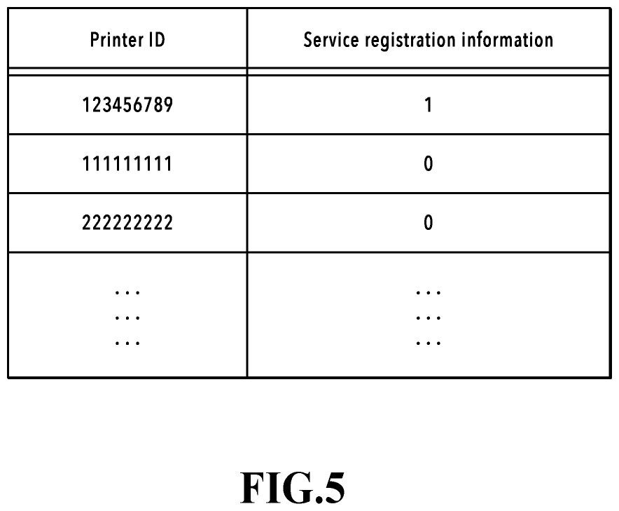

At S403, in response to the above-described request, the cartridge information is read from the RAM 113 or the HDD 114 by the storage processing module 204 of the SFP 101. Then, at S404, by the storage processing module 204, the service registration information is read from the RAM 113 or the HDD 114. FIG. 5 is a diagram showing an example of the service registration information. In the service registration information in FIG. 5, “Printer ID” that uniquely identifies the SFP 101 and “Service registration information” that indicates the situation of registration to the cartridge automatic order service by two values, that is, “1 (registered)” and “0 (unregistered)” are stored in association with each other. Here, it is assumed that the printer ID of the SFP 101 is “123456789”. The value of the service registration information corresponding to this is “1”, and therefore, the SFP 101 is registered as the target printer of the cartridge automatic order service. This service registration information is managed in the information management server 103 and the SFP 101 acquires the service registration information from the information management server 103 by, for example, polling and stores in the RAM 113 or the HDD 114. Processing to acquire the service registration information from the information management server 103 and store in the RAM 113 or the like will be explained with reference to another flow. Here, the value of the service registration information is taken to be “1” or “0”, but the values are not limited to those and it is needless to say that the number of patterns increases in accordance with the number of services to be provided.

At S405, based on the service registration information read at S404, the processing to which the processing advances next is branched. Specifically, in a case where the value of the service registration information is “1”, the processing advances to S406 and in a case of “0”, the processing advances to S407.

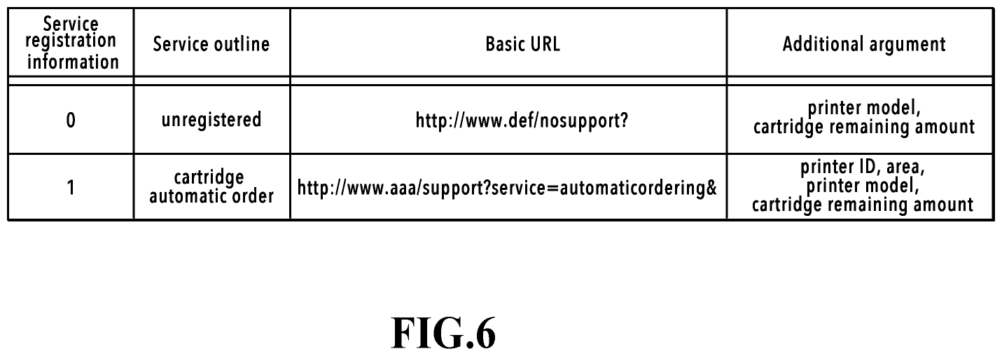

At S406, by the access information generation module 203, an access destination URL in view of that the SFP 101 is registered to the cartridge automatic order service is generated. At this time, the access destination DB 208 is referred to via the storage processing module 204. FIG. 6 is a diagram showing an example of information stored in the access destination DB 208 and “Service outline”, “Basic URL”, and “Additional argument” are stored in association with the service registration information. In FIG. 6, the basic URL corresponding to a case where the value of the service registration information is “1” is “http://www.aaa/support?service=automaticordering&” and the additional arguments are four of “printer ID”, “area”, “printer model”, and “toner remaining amount”. The basic URL is determined by, for example, the registration information management module 303 based on the service registration information. Here, the additional argument refers to the argument that completes the access destination URL, which is added to the basic URL. The access destination URL that is generated in a case where the value of the service registration information is “1” is, for example, as follows.

http://www.aaa/support?service=automaticordering&id=123456789&locale=jp&model=F900&Y=low&M=ok&C=ok&BK=out

In the above-described access destination URL, “id=123456789” corresponds to “printer ID”, “locale=jp” corresponds to “area”, “model=F900” corresponds to “printer model”, and “Y=low&M=ok&C=ok&BK=out” corresponds to “toner remaining amount”, respectively.

At S407, by the access information generation module 203, an access destination URL in view of that the SFP 101 is not registered to the cartridge automatic order service is generated. That is, by using the basic URL “http://www.def/nosupport?” corresponding to a case where the value of the service registration information is “0” and the two additional arguments “printer model” and “toner remaining amount”, for example, an access destination URL as follows is generated.

http://www.def/nosupport?model=F900&Y=low&M=ok&C=ok&BK=out

At S408, by the communication control module 202, the cartridge information read at S403 and the information on the access destination URL generated at S406 or S407 are transmitted to the PC 102.

At S409, in the PC 102, based on the cartridge information received from the SFP 101, the presence/absence of a cartridge whose toner remaining amount is less than or equal to a predetermined threshold value (for example, 10%) is determined. This determination processing is processing to check whether the degree of use of the automatic order service-target product reaches a predetermined condition. It is possible for a user to arbitrarily set the above-described threshold value in a case where the target product is a cartridge and the threshold value may be the same as the threshold value in the automatic order service described previously or may not be the same. In a case where there is a cartridge whose toner remaining amount is less than or equal to the threshold value, the processing advances to S410 and in a case where there is not such a cartridge, this processing is exited. Here, explanation is continued on the assumption that the toner remaining amount of the cartridge of cyan indicated in the received cartridge information is 100%, that of magenta is 80%, that of yellow is 8%, and that of black is 30%, and the processing advances to S410.

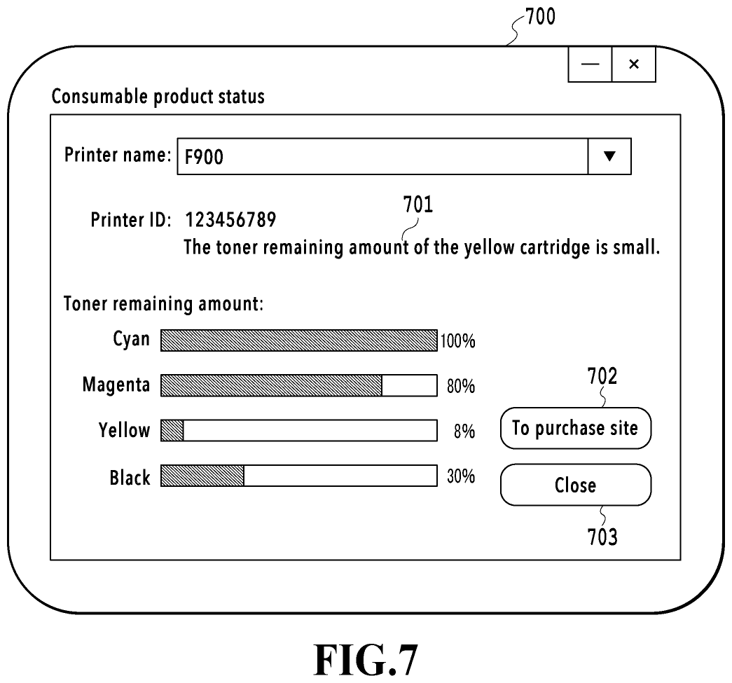

At S410, by the UI control module 311, a screen showing the status of a cartridge as a consumable product (consumable product status screen) is displayed on the monitor 126. FIG. 7 shows an example of the consumable product status screen on the above-described assumption. On a Consumable product status screen 700, in addition to an area in which the printer name and the printer ID are displayed, an area exists in which the toner remaining amount of each cartridge attached to the target printer (here, SFP 101) is indicated, and so on. Here, in the area in which the toner remaining amounts are indicated, the toner remaining amounts in accordance with the assumption described above are indicated and for the yellow cartridge whose toner remaining amount is smaller than the threshold value for determination of whether or not to display on the consumable product status screen, a warning message 701 is displayed. Then, at S411, in accordance with the operation contents of a user, the processing is branched. In a case where the contents of the user operation are pressing down of a “To purchase site” button 702, the processing advances to S412. On the other hand, in a case where the contents are pressing down of a “Close” button 703, this processing is terminated. As described previously, the consumable product management application 314 of the present embodiment is a resident application, and therefore, the termination here is equivalent to returning to S401.

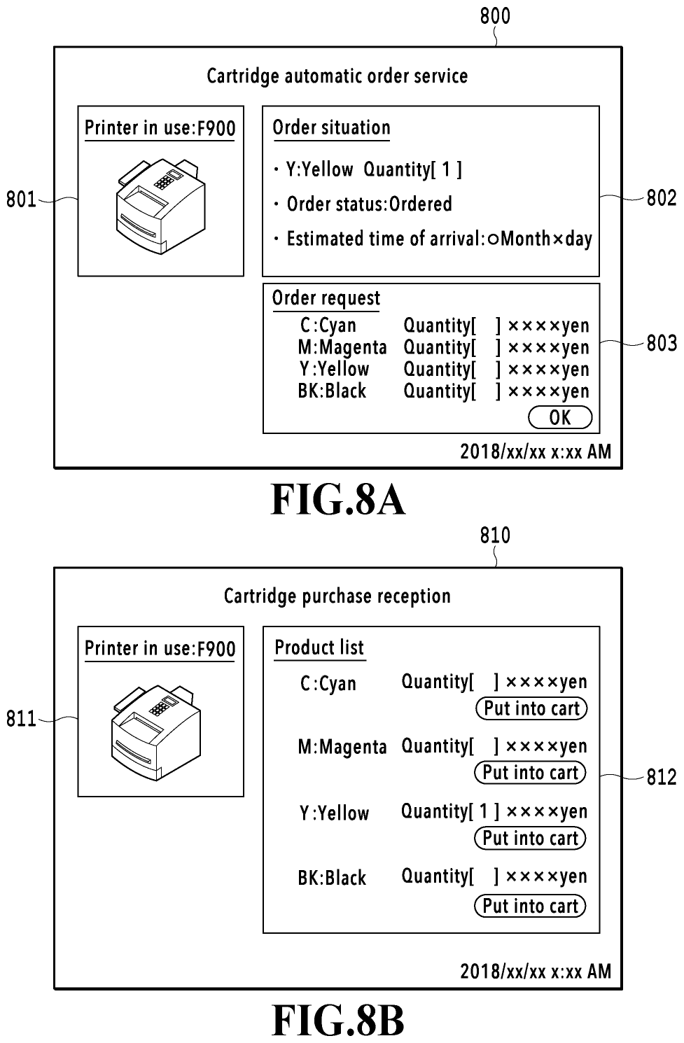

At S412, by the UI control module 311, the page screen of the site in accordance with the access destination URL received from the SFP 101 is displayed by using the WEB browser. FIG. 8A and FIG. 8B are each an example of the page screen that is displayed on the monitor 126 at this time. A screen 800 in FIG. 8A is the page screen (cartridge automatic order service screen) corresponding to the access destination URL in a case where subscription to the cartridge automatic order service is completed. This cartridge automatic order service screen 800 includes a model display area 801, an order situation display area 802, and an order request reception area 803. In the example of the consumable product status screen shown in FIG. 7, of the four cartridges mounted on the printing unit 118 of the SFP 101, yellow (Y) is “Toner remaining mount: 8%”. At this time, by the order management module 301 of the information management server 103, the automatic order processing of the yellow (Y) cartridge is performed and a message “Ordered” indicating this fact is displayed in the order situation display area 802. It may also be possible to display information on the shipment situation in the order situation display area 802 in place of (or in addition to) the order situation. Further, in the order request reception area 803, it is also possible for a user to order a cartridge at his/her discretion and in a case where a user specifies a desired cartridge and presses down an “OK” button, the cartridge is sent to the address registered as the destination of the cartridge at the time of the prior registration.

Further, a screen 810 in FIG. 8B is a page screen (cartridge purchase reception screen) corresponding to the access destination URL in a case where a user has not subscribed to the cartridge automatic order service. The cartridge purchase reception screen 810 includes a model display area 811 and a product list display area 812. The model display area 811 is the same as the model display area 801 on the UI screen 800 described above. In the product list display area 812, in accordance with the toner remaining amount of the cartridge, which is sent from the SFP 101, the predicted necessary number of cartridges for each cartridge is displayed. For example, in the example of the consumable product status screen shown in FIG. 7, yellow (Y) is “Toner remaining amount: 8%”. Consequently, it is determined that the possibility that a user orders the yellow (Y) cartridge is strong, and therefore, the number corresponding to the Y cartridge is displayed as “1”. As described above, by determining the access destination URL that is displayed on the consumable product status screen in accordance with the situation of subscription to the cartridge automatic order service, it is made possible to guide a user to an appropriate information site.

The above is the contents of the operation by the consumable product management application 314. Due to this, it is made possible for a user to browse an appropriate site in accordance with the situation of registration to the automatic order service for consumable product from the PC 102, which is a client terminal.

### (Acquisition/Storage of Service Registration Information)

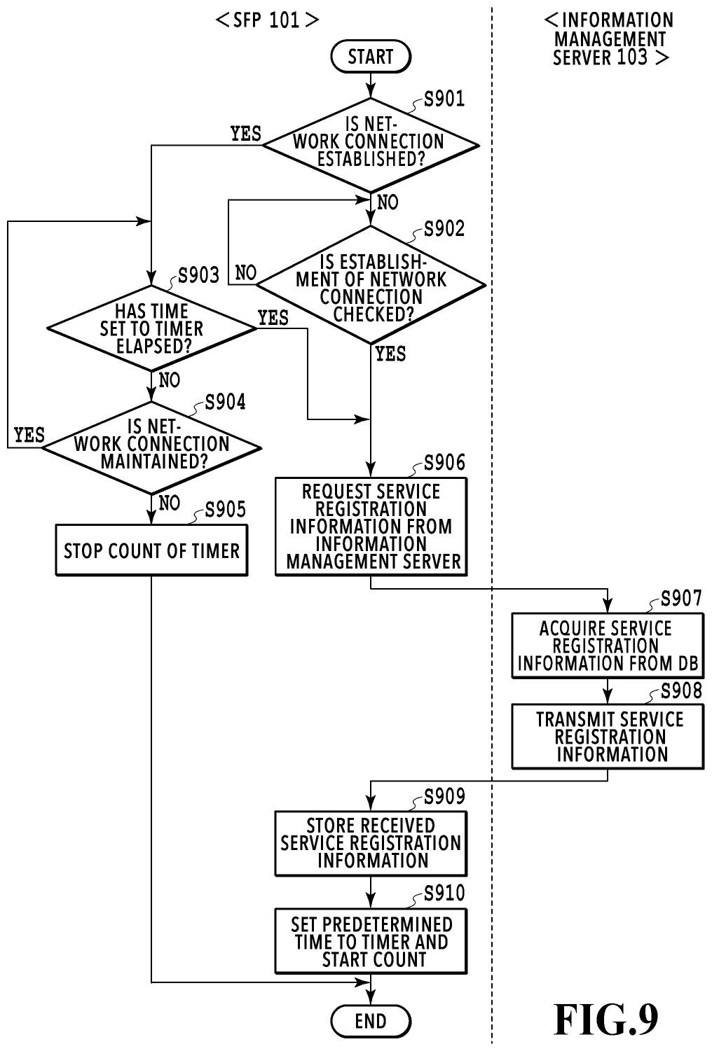

FIG. 9 is a flowchart showing a flow of processing for the SFP 101 to acquire and store service registration information from the information management server 103 by polling. Of each operation (step) of the flowchart shown in FIGS. 9, S901 to S906, S909, and S910 are performed on the side of the SFP 101 and S907 and S908 are performed on the side of the information management server 103. In the following explanation, “S” represents a step.

First, at S901, whether network connection is established with the information management server 103 is determined. The LAN control module 202 monitors the state of connection to the network 100 and at this step, processing is branched in accordance with the connection state. In a case where the network connection is established, the processing advances to S903 and in a case where the network connection is not established, the processing advances to S902.

At S902, monitoring is continued until network connection is established. In a case where establishment of network connection is checked, the processing advances to S906. On the other hand, at S903, whether a predetermined time specifying a polling interval that is set to a timer has elapsed is determined. The predetermined time will be described later. In a case where the predetermined time has elapsed, the processing advances to S906 and in a case where the predetermined time has not elapsed yet, the processing advances to S904. Then, at S904, whether the network connection is maintained is checked and in a case where the network connection is maintained, the processing returns to S903 and in a case where the network connection is disconnected, the processing advances to S905. At S905, the count operation in the above-described timer is stopped. After the stop of the count operation of the timer, this processing is exited. At S906, the information management server 103 is accessed via the communication I/F 119 and at the same time, a request to acquire service registration information is transmitted. Along with the acquisition request, the printer ID of the SFP 101 is also sent.

At S907, in the information management server 103 having received the acquisition request from the SFP 101, the registration information management module 303 is activated and the service registration information associated with the printer ID of the SFP 101 is read from the DB 304. At S908 that follows, the read service registration information is transmitted to the SFP 101.

At S909, in the storage processing module 204 of the SFP 101, the service registration information received from the information management server 103 is stored in the HDD 114. Then, at S910, in the timer processing module 207, a predetermined time specifying the polling interval for acquiring the service registration information is set to the timer and the count operation is started. The predetermined time at this time is arbitrary, and in a case where the service registration information is acquired, for example, each time 24 hours elapse, ‘86,400 (sec)” is set.

The above is the contents of the processing to acquire and store the service registration information from the information management server 103 by polling.

### Modification Example

In the flow in FIG. 4, generation of the access destination URL is performed on the side of the SFP 101, but this is not limited. For example, it may also be possible to design a configuration in which the processing to acquire and store service registration information from the information management server 103 explained in FIG. 9 is performed in the PC 102 and generation of the URL information is also performed in the PC 102. Also in a case of a configuration in which the PC 102 includes the function of the information management server 103, generation of the access destination URL is performed in the PC 102.

Further, in the embodiment described above, explanation is given on the assumption that the consumable product management application 314 is the resident application that boots at the same time of booting of the OS of the PC 102, but this is not limited. For example, it may also be possible to design a configuration in which the application boots at the same time of booting of the printer driver 313 or the application boots in response to explicit instructions of a user. At this time, it is sufficient to design the configuration so that a request for cartridge information is made at the time of booting of the application irrespective of the elapsed time of a predetermined time by a timer.

Further, in the flow in FIG. 4, in a case where the toner remaining amount becomes less than or equal to the threshold value, the consumable product status screen is displayed and the screen of a site in accordance with the situation of registration to the automatic order service for consumable product is displayed in response to pressing down of the “To purchase site” button. However, in a case where the toner remaining amount is less than or equal to the predetermined threshold value and it has been made clear that registration to the automatic order service for consumable product is completed from URL information or the like, it may also be possible to immediately display the cartridge automatic order service screen in FIG. 8A without waiting for the “To purchase site” button being pressed down. Alternatively, it may also be possible to display a consumable product status screen including the contents of the cartridge automatic order service screen.

As explained above, according to the present embodiment, it is possible to provide a user with appropriate information relating to arrangements of a consumable product or the like in accordance to the situation of registration to the automatic order service for consumable product, and therefore, convenience of the user improves.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to provide appropriate information to a user in accordance with the state of subscription to the automatic order service of consumable products and the like, and therefore, convenience of the user improves.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-179332, filed Sep. 25, 2018 which is hereby incorporated by reference wherein in its entirety.

What is claimed is:

1. An information processing apparatus that is connected via a network to an apparatus which has a capability of receiving an automatic order service for consumable product and in which an application that manages the consumable product is installed, wherein,
the application has a function to display a site relating to the consumable product on a display unit of the information processing apparatus and
the site that is displayed on the display unit is different between a case where the apparatus has been registered to the automatic order service and a case where the apparatus has not been registered to the automatic order service.

2. The information processing apparatus according to claim 1, wherein
the application displays:
a site including information on an order situation or a shipment situation of the consumable product in a case where registration to the automatic order service is completed; and
a site to purchase the consumable product in a case where registration to the automatic order service is not completed.

3. The information processing apparatus according to claim 1, wherein
the application acquires access information on the site relating to the consumable product from the apparatus via the network and displays a site indicated by the acquired access information on the display unit.

4. The information processing apparatus according to claim 1, wherein
the application:
stores service registration information indicating whether the registration has been completed in a storage unit of the information processing apparatus;
generates access information on the site relating to the consumable product based on the service registration information; and
displays a site indicated by the generated access information on a display unit.

5. The information processing apparatus according to claim 3, wherein
the application:
further acquires information indicating a use situation of the consumable product from the apparatus via the network; and
displays the site indicated by the access information in a case where a degree of use of the consumable product reaches a predetermined condition by the acquired information indicating the use situation.

6. The information processing apparatus according to claim 5, wherein
the application further displays a status screen including information on the degree of use of the consumable product in a case where the degree of use of the consumable product reaches a predetermined condition by the acquired information indicating the use situation.

7. The information processing apparatus according to claim 6, wherein
the application displays the site relating to the consumable product in response to a predetermined button located on the status screen being selected.

8. The information processing apparatus according to claim 1, wherein
the application is a resident application that boots in accordance with booting of an OS of the information processing apparatus.

9. he information processing apparatus according to claim 1, wherein
the apparatus is an apparatus having a print function and
the consumable product is a consumable product used for printing processing.

10. The information processing apparatus according to claim 9, wherein
the consumable product is one of a cartridge containing a color material, a printing sheet, and a conveyance roller.

11. A non-transitory computer readable storage medium storing an application program that manages a consumable product for causing a computer to perform a control method of an information processing apparatus that is connected via a network to an apparatus which has a capability of receiving an automatic order service for consumable product, the control method comprising the step of:
displaying a site with contents relating to the consumable on a display unit of the information processing apparatus, which are different between a case where the apparatus has been registered to the automatic order service and a case where the apparatus has not been registered to the automatic order service.

12. The storage medium according to claim 11, wherein
a site including information on an order situation or a shipment situation of the consumable product is displayed in a case where registration to the automatic order service is completed and
a site to purchase the consumable product is displayed in a case where registration to the automatic order service is not completed.

13. The storage medium according to claim 11, wherein
access information on the site relating to the consumable product is acquired from the apparatus via the network and a site indicated by the acquired access information is displayed on the display unit.

14. The storage medium according to claim 11, wherein
service registration information indicating whether the registration has been completed to the automatic order service is stored in a storage unit of the information processing apparatus,
access information on the site relating to the consumable product is generated based on the service registration information, and
a site indicated by the generated access information is displayed on a display unit.

15. The storage medium according to claim 13, wherein
information indicating a use situation of the consumable product is further acquired from the apparatus via the network and
the site indicated by the access information is displayed in a case where a degree of use of the consumable product reaches a predetermined condition by the acquired information indicating the use situation.

16. The storage medium according to claim 15, wherein
a status screen including information on the degree of use of the consumable product is displayed in a case where the degree of use of the consumable product reaches a predetermined condition by the acquired information indicating the use situation.

17. The storage medium according to claim 16, wherein
the site relating to the consumable product is displayed in response to a predetermined button located on the status screen being selected.

18. The storage medium according to claim 11, wherein
the application program is a resident application program that boots in accordance with booting of an OS of the information processing apparatus.
